(19) United States
(12) Patent Application Publication
(10) Pub. No.: US 2026/0112597 A1
(43) Pub. Date: Apr. 23, 2026

(54) NEGATIVE ELECTRODE PRODUCING METHOD AND NEGATIVE ELECTRODE PRODUCING APPARATUS

(71) Applicant: TOYOTA JIDOSHA KABUSHIKI KAISHA, Toyota-shi, (JP)

(72) Inventor: Minehiro FUNATO, Toyota-shi (JP)

(73) Assignee: TOYOTA JIDOSHA KABUSHIKI KAISHA, Toyota-shi (JP)

(21) Appl. No.: 19/248,988

(22) Filed: Jun. 25, 2025

(30) Foreign Application Priority Data
Oct. 17, 2024 (JP) 2024-181789

(51) Int. Cl. H01M 4/04; H01M 4/587

(52) U.S. Cl. CPC H01M 4/0404; H01M 4/587

(57) ABSTRACT

A negative electrode producing method includes supplying metal foil functioning as a current collector with a negative electrode composite material containing a negative electrode active material including graphite, and applying, to the negative electrode active material, a magnetic field with lines of magnetic force pointing in a direction perpendicular to a surface of the metal foil. The applying the magnetic field to the negative electrode active material includes, while conveying the metal foil in a conveyance direction, continuously applying the magnetic field using a plurality of magnets, the magnets being disposed at predetermined intervals in the conveyance direction.

### CROSS-REFERENCE TO RELATED APPLICATION

This application claims priority to Japanese Patent Application No. 2024-181789 filed on Oct. 17, 2024. The disclosure of the above-identified application, including the specification, drawings, and claims, is incorporated by reference herein in its entirety.

### BACKGROUND

### 1. Technical Field

The present disclosure relates to a negative electrode producing method, and a negative electrode producing apparatus.

### 2. Description of Related Art

Various techniques have been proposed for a method of producing a battery as disclosed in Japanese Unexamined Patent Application Publication No. 2024-73970 (JP 2024-73970 A) and WO 2012/124033.

### SUMMARY

Graphite that is used as a negative electrode active material has a structure in which many layers each having continuous six-membered carbon rings are stacked, and ions such as lithium ions are inserted between the layers during charging. Typically, in graphite, the in-plane direction of the layer having the continuous six-membered rings is represented as the direction of the (002) plane, and the stacking direction of the layers each having the continuous six-membered rings is represented as the direction of the (110) plane. During charging, ions such as lithium ions enter between the layers in the in-plane direction of the layers, that is, along the (002) plane, from the vicinity of an edge portion of the layer having the continuous six-membered rings. Thus, the orientation of the (002) plane of the graphite in the direction of a positive electrode enables the entry of the ions into the graphite and the diffusion of the ions from the graphite to efficiently progress.

JP 2024-73970 A discloses a method of producing a lithium-ion secondary battery, the producing method including supplying metal foil functioning as a current collector with a negative electrode composite material containing graphite, and applying a magnetic field with lines of magnetic force pointing in a direction perpendicular to a surface of the metal foil supplied with the negative electrode composite material. The producing method described in JP 2024-73970 A orients the graphite that is a negative electrode active material in the applying the magnetic field. JP 2024-73970 A states that the shorter magnetic field application time in the applying the magnetic field is better, and that the graphite is preferably sufficiently oriented within a short time of approximately 0.5 seconds. JP 2024-73970 A also states that the strength of the magnetic field in the applying the magnetic field is 1.0 [T] or more, preferably 1.5 [T] or more, and more preferably 2.0 [T] or more. However, there is room for improvement in the applying the magnetic field in order to increase the degree of orientation of the graphite in the negative electrode.

The present disclosure has been made in view of the above circumstances, and a main object thereof is to provide a negative electrode producing method that can improve the degree of orientation of graphite that is a negative electrode active material.

That is, the present disclosure includes the following aspects.
<1> A negative electrode producing method including:
   supplying metal foil functioning as a current collector with a negative electrode composite material containing a negative electrode active material including graphite; and
   applying, to the negative electrode active material, a magnetic field with lines of magnetic force pointing in a direction perpendicular to a surface of the metal foil, wherein the applying the magnetic field to the negative electrode active material includes, while conveying the metal foil in a conveyance direction, continuously applying the magnetic field using a plurality of magnets, the magnets being disposed at predetermined intervals in the conveyance direction.
<2> The negative electrode producing method according to <1>, further including drying the negative electrode composite material after the applying the magnetic field.
<3> The negative electrode producing method according to <1> or <2>, wherein a coating weight of the negative electrode composite material is 25 mg/cm² or more.
<4> The negative electrode producing method according to any one of <1> to <3>, wherein:
   time to apply the magnetic field is 0.36 seconds or more and 5.04 seconds or less; and
   in the applying the magnetic field, time for the metal foil to pass through each of the magnets is 0.18 seconds.
<5> A negative electrode producing apparatus including:
   a supply unit configured to supply metal foil functioning as a current collector with a negative electrode composite material containing a negative electrode active material including graphite; and
   a magnetic field application unit configured to apply, to the negative electrode active material, a magnetic field with lines of magnetic force pointing in a direction perpendicular to a surface of the metal foil, wherein
   the magnetic field application unit includes a plurality of magnets configured to apply the magnetic field, the magnets being disposed at predetermined intervals in a conveyance direction of the metal foil.

The present disclosure can improve the degree of orientation of graphite that is a negative electrode active material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an example of a step of applying a magnetic field in a producing method of the present disclosure;

FIG. 2 is a diagram showing an example of a producing apparatus of the present disclosure;

FIG. 3 is a schematic sectional view showing a step of applying a magnetic field in a comparative example; and

FIG. 4 is a graph showing the relationship between the magnetic field application time and the degree of orientation in examples and comparative examples.

### DETAILED DESCRIPTION OF EMBODIMENTS

Hereinbelow, an embodiment according to the present disclosure will be described. Note that matters that are other than matters specifically mentioned in the present specification and that are necessary for carrying out the present disclosure (for example, the common configuration and producing process of a negative electrode that does not characterize the present disclosure) can be understood as design matters for those skilled in the art based on the related art in the field. The present disclosure can be carried out based on the details disclosed in the present specification and the technical common knowledge in the field.

In addition, the dimensional relationships (e.g., length, width, and thickness) in the drawings do not reflect the actual dimensional relationships.

### 1. Producing Method

The present disclosure provides a negative electrode producing method including a step of supplying metal foil functioning as a current collector with a negative electrode composite material containing a negative electrode active material including graphite (hereinbelow, may be referred to as the negative electrode composite material supply step), and a step of applying, to the negative electrode active material, a magnetic field with lines of magnetic force pointing in a direction perpendicular to a surface of the metal foil (hereinbelow, may be referred to as the magnetic field application step). The step of applying the magnetic field to the negative electrode active material includes, while conveying the metal foil in a conveyance direction, continuously applying the magnetic field using a plurality of magnets, the magnets being disposed at predetermined intervals in the conveyance direction.

Hereinbelow, each step will be described.

### Negative Electrode Composite Material Supply Step

A negative electrode composite material supply step is the step of supplying metal foil functioning as a current collector with a negative electrode composite material containing a negative electrode active material including graphite. The negative electrode composite material forms a negative electrode layer containing the negative electrode active material.

The metal foil functions as the current collector of a negative electrode. In addition, the metal foil is required not to disturb the orientation of the graphite in the subsequent magnetic field application step. Specific examples of the metal foil include Al foil and Cu foil. The metal foil may be alloy foil, and the metal foil may contain a material other than metal.

The shape of the metal foil is not limited to any particular shape, and may be the same as the shape of metal foil used in conventional negative electrode production. For example, the shape may be a long (sheet) shape. The thickness of the metal foil is not limited to any particular thickness.

The negative electrode composite material contains at least graphite as the negative electrode active material, and may contain a negative electrode active material other than graphite or may contain only graphite as the negative electrode active material.

The graphite may be a material that can absorb and release ions such as lithium ions, and has an edge portion that serves as ion inlet and is oriented by the application of a magnetic field. The graphite may have, for example, a layer structure in which hexagonal plate-shaped crystals are stacked to form a plurality of layers. Specifically, examples of the graphite include natural graphite, artificial graphite, amorphous carbon of natural graphite, and amorphous carbon of artificial graphite. As the negative electrode active material other than graphite, a conventionally known material may be used as appropriate.

The amount of graphite contained in the negative electrode composite material may be, for example, an amount that makes the amount of graphite contained in the entire negative electrode layer 80% by mass or more and 99% by mass or less, or 90% by mass or more and 97.95% by mass or less. The amount that makes the amount of graphite contained in the entire negative electrode layer 80% by mass or more means that the amount of graphite contained in the entire negative electrode layer formed by removing a volatile component such as a solvent contained in the negative electrode composite material is 80% by mass or more. The same applies to components other than the graphite and the solvent.

The negative electrode composite material may contain an additional component other than the negative electrode active material, and may contain a binder as the additional component, for example. Examples of the binder include styrene-butadiene rubber (SBR), carboxymethyl cellulose (CMC), polytetrafluoroethylene (PTFE), polyethylene (PE), polyacrylic acid (PAA), and polyvinylidene fluoride (PVdF). Note that each of the materials listed above as an example of the binder may be used to deliver the function as a thickener or other additives for the negative electrode composite material in addition to the function as the binder.

The amount of the binder contained in the negative electrode composite material may be, for example, an amount that makes the amount of the binder contained in the entire negative electrode layer 0.4% by mass or more and 10% by mass or less, or 0.4% by mass or more and 5% by mass or less.

The negative electrode composite material may contain a conductive material as the additional component. Examples of the conductive material include carbon nanotube (CNT), acetylene black, carbon black, and Ketjenblack. The amount of the conductive material contained is not limited to any particular amount, and may be, for example, an amount that makes the amount of the conductive material contained in the entire negative electrode layer 0.05% by mass or more, 1% by mass or less, or 0.5% by mass or less.

The negative electrode composite material may contain a solvent that disperses the above-mentioned components. Examples of the solvent include organic solvents such as N-methylpyrrolidone (NMP), pyrrolidone, methyl ethyl ketone, methyl isobutyl ketone, cyclohexanone, toluene, dimethylformamide, and dimethylacetamide. Alternatively, the solvent may be water or a mixed solvent mainly containing water. As a solvent other than water that constitutes the mixed solvent, an organic solvent (such as lower alcohol or lower ketone) that can be uniformly mixed with water can be selected and used as appropriate.

The amount of the solvent contained in the negative electrode composite material is not limited to any particular amount.

The orientation of the graphite in the negative electrode composite material typically increases as the viscosity of the negative electrode composite material decreases. However, in the producing method of the present disclosure, since the orientation of the graphite is high, the graphite can be sufficiently oriented without reducing the viscosity of the negative electrode composite material. Thus, the negative electrode composite material may be, for example, slurry (paste) having a high viscosity of 100000 mPa·s or more at a shear rate of 0.01 s 1.

A method of supplying the metal foil with the negative electrode composite material is not limited to any particular method, and a common method can be used. One example of the method is a coating method using an applicator such as a die coater. Being possible to ensure sufficient orientation of the graphite even when a high-viscosity negative electrode composite material, that is, a negative electrode composite material with a small amount of solvent is used means being possible to achieve both heavy coating weight of the negative electrode and high orientation of the graphite. The producing method of the present disclosure can set the coating weight of the negative electrode composite material to 25 mg/cm² or more. The coating weight of the negative electrode composite material may be 200 mg/cm² or less, 100 mg/cm² or less, or 40 mg/cm² or less.

### Magnetic Field Application Step

The magnetic field application step is the step of applying, to the negative electrode active material in the negative electrode composite material supplied onto the metal foil (current collector) in the negative electrode composite material supply step, a magnetic field with lines of magnetic force pointing in a direction perpendicular to a surface of the metal foil, and the step of, while conveying the metal foil in a conveyance direction, continuously applying the magnetic field using a plurality of magnets, the magnets being disposed at predetermined intervals in the conveyance direction. By causing the magnetic field with the lines of magnetic force pointing in the direction perpendicular to the surface of the metal foil to act, the graphite (negative electrode active material) on the metal foil is oriented such that a plane (002) between the layers becomes parallel to the lines of magnetic force.

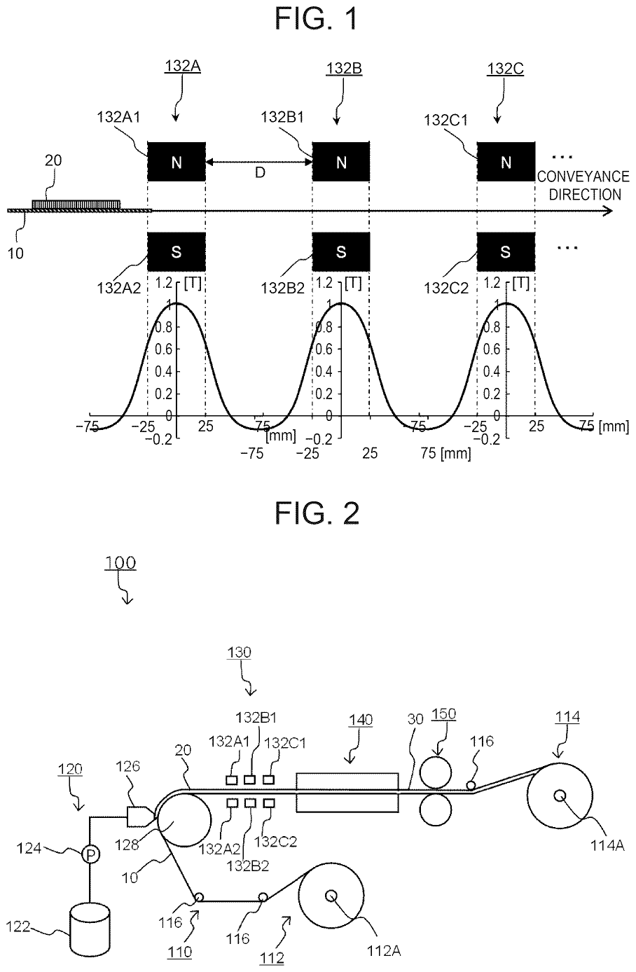

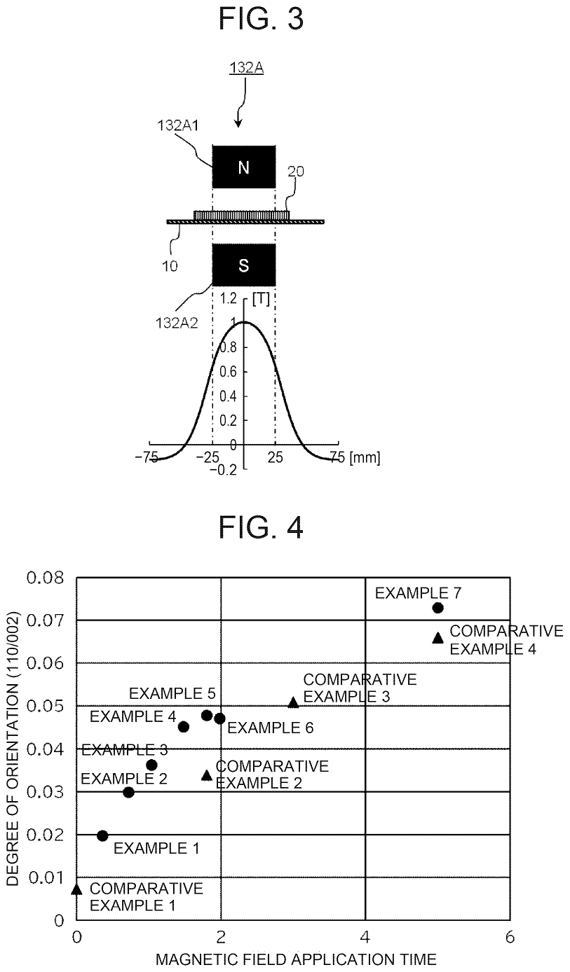

As a result of intensive research conducted by the present researcher, it has been found that the degree of orientation of the graphite on the metal foil can be improved by disposing the magnets at predetermined intervals in the conveyance direction of the metal foil (hereinbelow, may be simply referred to as the conveyance direction) to form a magnetic field distribution in which the magnetic fields of the adjacent magnets are continuous as described above. Specifically, (1) a case in which a magnetic field is applied by stationarily placing metal foil supplied with a negative electrode composite material (containing graphite) with respect to one magnet (refer to FIG. 3) and (2) a case in which a magnetic field is applied by conveying metal foil supplied with a negative electrode composite material (containing graphite) along a plurality of magnets disposed at predetermined intervals (refer to FIG. 1) were compared. As a result, it has been confirmed that the degree of orientation of the graphite is higher in the case (2) in which the magnets are disposed at the predetermined intervals, even with the same application time.

A magnetic field distribution pattern formed in the magnetic field application step of the producing method of the present disclosure will be described with reference to FIG. 1. FIG. 1 is a schematic diagram showing an example of the magnetic field application step in the producing method of the present disclosure.

In FIG. 1, a negative electrode composite material 20 is supplied on metal foil 10 that is the current collector. The magnets that form the magnetic field with the lines of magnetic force pointing in the direction perpendicular to the surface of the metal foil 10 are a plurality of magnets 132A, 132B, 132C disposed at predetermined intervals in the conveyance direction of the metal foil 10. Here, the “perpendicular direction” does not have to be a perfect perpendicular direction and allows a predetermined error. The magnet 132A is a pair of magnets (hereinbelow, may be referred to as the magnet unit) including a magnet 132A1 and a magnet 132A2. The magnet 132B is a pair of magnets (magnet unit) including a magnet 132B1 and a magnet 132B2. The magnet 132C is a pair of magnets (magnet unit) including a magnet 132C1 and a magnet 132C2. Each of the magnets 132A to 132C is disposed such that the metal foil 10 is sandwiched between the magnets of the magnet unit. In addition, each magnet unit is disposed such that the N-pole of one of the magnets (132A1, 132B1, 132C1) and the S-pole of the other one of the magnets (132A2, 132B2, 132C2) face the metal foil 10.

The magnets 132 that are adjacent to each other are disposed at a predetermined interval D and form a magnetic field distributions pattern in which the magnetic field distributions of the adjacent magnets 132 are continuous. Specifically, each magnet 132A, 132B, 132C forms a magnetic field distribution having a positive magnetic flux that is a strong magnetic field and a negative magnetic flux that is a weak reverse magnetic field as shown in FIG. 1. These magnets being disposed at the intervals D form the magnetic field distribution in which the magnetic fields of the adjacent magnets are continuous. With such a continuous magnetic field distribution pattern, the strong magnetic field and the weak reverse magnetic field are continuously and repeatedly applied to the graphite on the metal foil. It is considered that, as a result of the above, an acceleration is applied to the graphite on the metal foil, and the mobility of the graphite in the negative electrode composite material is increased. Thus, it is considered that the method of the present disclosure makes the degree of orientation of the graphite higher than that in the case in which the metal foil is stationarily placed with respect to one magnet unit 132A as shown in FIG. 3 and the magnetic field formed only by the magnet unit 132A is applied to the graphite in the negative electrode composite material.

As described above, the producing method of the present disclosure can improve the degree of orientation of the graphite that is the active material and, as a result, can provide the negative electrode having excellent ion diffusivity (ionic conductivity).

In addition, since the producing method of the present disclosure can orient the graphite within a shorter time than the conventional methods, the producing method of the present disclosure has an advantage in that the negative electrode producing time can be shortened. Furthermore, even when the viscosity of the negative electrode composite material is high, it is possible to increase the degree of orientation of the graphite. Thus, it is easy to achieve heavy coating weight of the negative electrode and also possible to shorten the time of the step of drying the electrode composite material. In addition, since a high-viscosity negative electrode composite material can be used, it is also possible to restrain the occurrence of sagging when the negative electrode composite material is supplied to the metal foil.

The number of magnets disposed in the conveyance direction is not limited to any particular number as long as it is two or more, and may be selected as appropriate in accordance with the magnetic force of each magnet, the viscosity and the coating weight of the negative electrode composite material on the metal foil. For example, the number of magnets may be three or more, five or more, or eight or more.

Each magnet used in the embodiment shown in FIG. 1 is the magnet unit including the pair of magnets and disposed such that the N-pole of one of the magnets and the S-pole of the other one of the magnets face the metal foil. However, in the present disclosure, each magnet does not necessarily have to be the magnet unit. By using the magnet unit as described above, a strong magnetic field can be applied. In the present disclosure, although the magnet unit includes the pair of magnets, the magnet unit is considered to be one magnet, and one magnet unit is not considered to be a plurality of magnets. The magnets are disposed in the conveyance direction, and a pair of magnets that constitutes one magnet unit is typically disposed intersecting the conveyance direction.

Although, in FIG. 1, each magnet unit 132 is disposed such that the S-pole faces a lower face side of the metal foil 10 and the N-pole faces the upper face side of the metal foil 10 (the side supplied with the negative electrode composite material 20), the orientation of the S-pole and the N-pole is not limited to this mode and can be selected as appropriate.

The type of each magnet is not limited to any particular type, and may be, for example, a permanent magnet or an electromagnetic magnet.

The magnets are disposed at the predetermined intervals in the conveyance direction. If the magnets are disposed without leaving any interval therebetween, the negative magnetic field is not formed, and sufficient magnetic field application effect cannot be obtained. On the other hand, it is considered that the magnetic field application effect does not change within a range in which the interval between the magnets is more than the length of each magnet in the conveyance direction.

The interval between the magnets may be set as appropriate, and may be, for example, 1 mm or more, 1 cm or more, or 10 cm or less.

Although the length of each magnet in the conveyance direction is not limited to any particular length, a too long length results in a small magnetic force around the middle of the length of the magnet in the conveyance direction. Thus, the length of each magnet in the conveyance direction may be set as appropriate, taking into consideration the magnetic force of the magnet and the like.

In the strength of the magnetic field formed by each magnet, for example, the maximum value of the magnetic flux density of the strong magnetic field may be 0.5 T or more, 0.75 T or more, or 1.0 T or more.

Although the time to apply the magnetic field depends on the strength of the magnetic field formed by the magnets, the time may be, for example, 0.36 seconds or more, or 5.04 seconds or less.

The time to apply the magnetic field is the total time for the metal foil to pass through each magnet. The time for the metal foil to pass through one magnet may be, for example, 0.1 seconds or more, 0.15 seconds or more, or 0.18 seconds or more.

A specific example of the magnetic field application conditions is a mode in which the time to apply the magnetic field is 0.36 seconds or more and 5.04 seconds or less, and the time for the metal foil to pass through each magnet is 0.18 seconds.

### Drying Step

The drying step is the step of drying the negative electrode composite material.

A drying method is not limited to any particular method, as long as the solvent in the negative electrode composite material can be dried and removed, and a known method can be used. Examples of the drying method include hot-air drying, and infrared drying. As described above, the method of the present disclosure can use the high-viscosity negative electrode composite material with a small amount of solvent. Thus, it can be said that, compared to conventional methods, it is possible to shorten and simplify the drying step.

The drying step is typically performed after the magnetic field application step. This is because the graphite in the negative electrode composite material cannot be oriented after the negative electrode composite material is dried.

### Others

The negative electrode producing method of the present disclosure may have an additional step other than the negative electrode composite material supply step, the magnetic field application step, and the drying step described above. One example of the additional step is a rolling step of rolling the negative electrode layer obtained in the drying step. A rolling method may be selected, for example, from known methods such as roll pressing and flat plate pressing.

The negative electrode provided by the producing method of the present disclosure can be used, for example, in a battery such as a lithium ion battery.

The battery in which the negative electrode obtained by the producing method of the present disclosure is used may be a primary battery or a secondary battery, but preferably a secondary battery. This is because the secondary battery can be repeatedly charged and discharged and is useful as an in-vehicle battery, for example. The shape of the battery is not limited to any particular shape and may be, for example, a coin shape, a cylindrical shape, a square shape, a sheet shape, a button shape, a flat shape, or a stacked shape.

Examples of the use of the battery including the negative electrode obtained by the producing method of the present disclosure include power sources for vehicles such as a hybrid electric vehicle (HEV), a plug-in hybrid electric vehicle (PHEV), a battery electric vehicle (BEV), a gasoline-powered vehicle, and a diesel-powered vehicle. In particular, the battery may be used as a power source for driving a hybrid electric vehicle (HEV), a plug-in hybrid electric vehicle (PHEV), and a battery electric vehicle (BEV). In addition, the battery may be used as a power source for mobile objects other than vehicles (e.g., a train, a ship, and an aircraft), and may be used as a power source for an electrical product such as an information processing device.

### 2. Producing Apparatus

The present disclosure provides a negative electrode producing apparatus including a supply unit that supplies metal foil functioning as a current collector with a negative electrode composite material containing a negative electrode active material including graphite (hereinbelow, may be referred to as the composite material supply unit), and a magnetic field application unit that applies, to the negative electrode active material, a magnetic field with lines of magnetic force pointing in a direction perpendicular to a surface of the metal foil. The magnetic field application unit includes a plurality of magnets for applying the magnetic field, the magnets being disposed at predetermined intervals in a conveyance direction of the metal foil.

Hereinbelow, the negative electrode producing apparatus of the present disclosure will be described with reference to FIG. 2. FIG. 2 shows an example of the negative electrode producing apparatus of the present disclosure. Note that, for the negative electrode producing apparatus of the present disclosure, the description of details that overlap those of the producing method of the present disclosure may be omitted.

In FIG. 2, a negative electrode producing apparatus 100 includes a conveyance path 110, a metal foil supply unit 112, a collection unit 114, a composite material supply unit 120, a magnetic field application unit 130, a drying unit 140, and a rolling unit 150.

The conveyance path 110 is the path for conveying the metal foil (current collector) 10. In the embodiment shown in FIG. 2, a plurality of guide rollers 116 is disposed along the path for conveying the metal foil 10. The metal foil 10 is passed over the guide rollers 116, and a predetermined tension is applied to the metal foil 10.

A starting end of the conveyance path 110 is provided with the metal foil supply unit 112 that supplies the metal foil 10. The metal foil supply unit 112 supplies, to the conveyance path 110, the metal foil 10 that has a long shape and is wound in a roll shape around a core 112A by rotating the core 112A. A terminal end of the conveyance path 110 is provided with the collection unit 114 that collects the metal foil 10. The collection unit 114 winds up the metal foil 10 that has undergone a predetermined process in the conveyance path 110 onto a core 114A.

On the conveyance path 110, the composite material supply unit 120, the magnetic field application unit 130, the drying unit 140, and the rolling unit 150 are disposed in order.

The composite material supply unit 120 supplies the metal foil 10 functioning as the current collector with the negative electrode composite material 20 containing the negative electrode active material including graphite. In the embodiment shown in FIG. 2, the composite material supply unit 120 is a die coater coating machine that applies the negative electrode composite material 20 to the metal foil 10 having a long shape in the longitudinal direction of the metal foil 10. In the composite material supply unit 120, the negative electrode composite material 20 stored in a tank 122 is suctioned by a pump 124 and supplied to a die 126. Then, while the metal foil 10 is being conveyed by rotating a backup roll 128, the metal foil 10 is passed through a clearance between the backup roll 128 and the die 126, and a coating of the negative electrode composite material 20 is formed on the surface of the metal foil 10 from the die 126.

The magnetic field application unit 130 applies, to the negative electrode active material in the negative electrode composite material 20 supplied onto the metal foil 10 by the composite material supply unit 120, the magnetic field with the lines of magnetic force pointing in the direction perpendicular to the surface of the metal foil 10. The magnets 132 for applying the magnetic field are disposed at the predetermined intervals in the conveyance direction of the metal foil 10.

In the embodiment shown in FIG. 2, the magnets 132A, 132B, 132C are disposed at the predetermined intervals in the conveyance direction of the metal foil 10. As with FIG. 1, each of the magnets 132A to 132C is a magnet unit including a pair of magnets, and disposed such that the metal foil 10 is sandwiched between the magnets of the magnet unit. In addition, each magnet unit is disposed such that the N-pole of one of the magnets (132A1, 132B1, 132C1) and the S-pole of the other one of the magnets (132A2, 132B2, 132C2) face the metal foil 10. The magnets 132A to 132C continuously apply, to the graphite (negative electrode active material) on the metal foil 10 conveyed in the conveyance path 110, the magnetic field with the lines of magnetic force pointing in the direction perpendicular to the surface of the metal foil 10.

The metal foil 10 that has been applied with the magnetic field by the magnetic field application unit 130 is conveyed to the drying unit 140 along the conveyance path 110. In the drying unit 140, the negative electrode composite material 20 on the metal foil 10 is dried to obtain a negative electrode layer 30. The metal foil 10 with the negative electrode layer 30 is conveyed to the rolling unit 150 along the conveyance path 110. In the rolling unit 150, the negative electrode layer 30 is rolled (pressed). In the present embodiment shown in FIG. 2, a roll press machine is used.

### Examples 1 to 7

Artificial graphite (negative electrode active material), CMC (thickener), SBR (binder), and CNT paste (conductive material) were mixed and dispersed using a planetary mixer to produce a negative electrode composite material (paste). The composition ratio of the negative electrode composite material is artificial graphite/CMC/SBR/CNT paste=97.95/0.4/1.6/0.05 by mass. The viscosity of the obtained negative electrode composite material is 212530 mPa·s at a shear rate of 0.01 s⁻¹.

The negative electrode composite material was applied to Cu foil that is a current collector using an applicator. The coating amount is a coating weight of 27.8 mg/cm² on one side.

Next, as shown in FIG. 1, the Cu foil with the negative electrode composite material was conveyed between magnets of a plurality of magnet units disposed at predetermined intervals in the conveyance direction of the Cu foil, and a magnetic field was continuously applied to the graphite in the negative electrode composite material.

Each magnet unit was disposed such that the S-pole of one of the magnets and the N-pole of the other one of the magnets face the surfaces of the Cu foil. Each magnet unit has a length of 50 mm in the conveyance direction and a maximum magnetic flux density value of 1 T in the strong magnetic field, and has a magnetic field distribution as shown in FIG. 1. As shown in FIG. 1, the magnet units were disposed side by side in the conveyance direction at intervals such that the magnetic fields of the adjacent magnet units are continuous.

The number of magnet units in each example is as shown in Table 1. The Cu foil was conveyed such that the Cu foil passes between the magnets of each magnet unit in 0.18 seconds. The magnetic field application time shown in Table 1 is calculated by the number of magnet units×0.18 (s).

After the application of the magnetic field, the negative electrode composite material was dried. X-ray diffraction (XRD) measurement was performed on the dried negative electrode, and the peak intensities of the 110 plane and the 002 plane were measured. The relative ratio of the peak intensity of the 110 plane to the peak intensity of the 002 plane (110/002) was calculated as the degree of orientation. The results are shown in Table 1 and FIG. 4.

Furthermore, the negative electrode density was brought to 1.25 g/cm³ by roll pressing.

### Comparative Example 1

The production of the negative electrode and the XRD measurement were performed in the same manner as in the examples except that the magnetic field application was not performed. The degree of orientation of the negative electrode is shown in Table 1 and FIG. 4.

### Comparative Examples 2 to 4

The production of the negative electrode and the XRD measurement were performed in the same manner as in the examples except that the Cu foil with the negative electrode composite material was stationarily placed between the magnets of one magnet unit for a predetermined time as shown in FIG. 3 and the magnetic field was applied to the graphite in the negative electrode composite material. The magnetic field application time is shown in Table 1, and the degree of orientation of the negative electrode is shown in Table 1 and FIG. 4.

TABLE 1

| | Number of | Magnetic Field | Degree of |
|---|---|---|---|
| | Magnet | Application | Orientation |
| | Units | Time (s) | (110/002) |
| Example 1 | 2 | 0.36 | 0.0198 |
| Example 2 | 4 | 0.72 | 0.0298 |
| Example 3 | 6 | 1.08 | 0.0363 |
| Example 4 | 8 | 1.44 | 0.0451 |
| Example 5 | 10 | 1.8 | 0.0478 |
| Example 6 | 11 | 1.98 | 0.0470 |
| Example 7 | 28 | 5.04 | 0.0729 |
| Comparative Example 1 | — | — | 0.0074 |
| Comparative Example 2 | 1 | 1.8 | 0.0339 |
| Comparative Example 3 | 1 | 3 | 0.0509 |
| Comparative Example 4 | 1 | 5 | 0.0660 |

As shown in Table 1 and FIG. 4, the examples show a higher degree of orientation than the comparative examples, even with the same magnetic field application time. That is, it has been confirmed that the method of the present disclosure can shorten the magnetic field application time. In addition, it has been found that the effect of improving the degree of orientation can be obtained even when a high-viscosity negative electrode composite material having a viscosity of 100000 mPa·s or more at a shear rate of 0.01 s⁻¹ is used.

What is claimed is:

1. A negative electrode producing method comprising:
supplying metal foil functioning as a current collector with a negative electrode composite material containing a negative electrode active material including graphite; and
applying, to the negative electrode active material, a magnetic field with lines of magnetic force pointing in a direction perpendicular to a surface of the metal foil, wherein
the applying the magnetic field to the negative electrode active material includes, while conveying the metal foil in a conveyance direction, continuously applying the magnetic field using a plurality of magnets, the magnets being disposed at predetermined intervals in the conveyance direction.

2. The negative electrode producing method according to claim 1, further comprising drying the negative electrode composite material after the applying the magnetic field.

3. The negative electrode producing method according to claim 1, wherein a coating weight of the negative electrode composite material is 25 mg/cm² or more.

4. The negative electrode producing method according to claim 1, wherein:
time to apply the magnetic field is 0.36 seconds or more and 5.04 seconds or less; and
in the applying the magnetic field, time for the metal foil to pass through each of the magnets is 0.18 seconds.

5. A negative electrode producing apparatus comprising:
a supply unit configured to supply metal foil functioning as a current collector with a negative electrode composite material containing a negative electrode active material including graphite; and
a magnetic field application unit configured to apply, to the negative electrode active material, a magnetic field with lines of magnetic force pointing in a direction perpendicular to a surface of the metal foil, wherein
the magnetic field application unit includes a plurality of magnets configured to apply the magnetic field, the magnets being disposed at predetermined intervals in a conveyance direction of the metal foil.
